(19) United States
(12) Patent Application Publication
(10) Pub. No.: US 2008/0281029 A1
(43) Pub. Date: Nov. 13, 2008

(54) Process for the Preparation of Aluminium Particles Coated with a Polymer Layer

(76) Inventors: Fabrice Morvan, Marie (FR); Herve Lelievre, Estialescq (FR); Etienne Duguet, Begles (FR); Nicolas Doreau, Talence (FR)

Correspondence Address: YOUNG & THOMPSON, 209 Madison Street, Suite 500, ALEXANDRIA, VA, 22314, US

(21) Appl. No.: 11/631,074

(22) PCT Filed: Jun. 28, 2005
(86) PCT No.: PCT/FR2005/001642

§ 371 Date: Dec. 28, 2006

(30) Foreign Application Priority Data
Jun. 29, 2004 (FR) 0407163

(51) Int. Cl. C09D 5/00; B05D 7/14; C08K 3/08

(52) U.S. Cl. 524/441; 427/216

(57) ABSTRACT

A method for coating aluminum particles with a polymer film, includes the following steps: (A) providing an aqueous dispersion of metal aluminum particles using surfactants, the aluminum particles being contacted with S₂O₈²⁻ persulphate anions; then (B) providing an emulsion type polymerization in the aqueous dispersion thus obtained, by introducing into the dispersion monomers whereof the free radical polymerization is initiated by the persulphate anions, or by introducing into the emulsion monomers and an initiator for polymerizing the monomers, whereby a polymer film is formed on the surface of the aluminum particles. The invention also concerns pigment compositions based on aluminum particles coated with polymer films, obtainable by the method, as well as the use of the compositions for formulation of paints having a metallized appearance.

The present invention relates to a process allowing possible to deposit fine layers of polymer on the surface of metallic aluminium particles, said coating of the aluminium particles leading to obtaining aluminium pigmentary compositions suitable especially for the formulation of paints of metallised appearance, and more specifically to the formulation of powder-type paints intended for application by electrostatic means.

Nowadays, a certain number of pigmentary compositions based on metallic aluminium particles coated with polymers are known which are usable in metallised paint compositions.

In particular, aluminium particles suitable for the formulation of paints are known from U.S. Pat. No. 4,434,009, said particles being obtained by a process which consists in dispersing the metallic particles in an organic solvent containing monomers, then effecting the polymerisation of the monomers by the addition of an initiator within the medium. This polymerisation process specifically takes place in a non-aqueous medium, namely in an organic solvent medium, thereby making it possible to avoid corrosion of the metallic aluminium particles by water, which would adversely affect their brilliance properties. It is in fact known that in an aqueous medium, unprotected metallic aluminium particles have a strong tendency to oxidise, so that a layer of oxide forms on their surface and dulls their appearance.

The process of U.S. Pat. No. 4,434,009 proves advantageous from many points of view. Thus, apart from the aforesaid preservation of the brilliance qualities of the aluminium particles during the manufacturing process, which makes it possible to obtain the metallised effect sought for the pigment, the coating process of U.S. Pat. No. 4,434,009 additionally makes it possible to respect the morphology of the starting pigment and to obtain coated particles which are protected from corrosion in their subsequent applications, and which may generally be employed in aqueous media, and in particular in formulations of water-based paints, without loss of their metallic brightness.

Another more specific advantage of the particles of the type of those obtained according to the process of U.S. Pat. No. 4,434,009 is that they prove specifically suited to the formulation of solid paints termed “powder-type” which are intended for application by electrostatic means.

A powder-type metallised paint based on aluminium particles is most often a powdery solid composition which contains a heat-setting mixture of resins and particles of metallic aluminium. Such a powder-type paint composition is used in general to produce coatings on metallic surfaces such as automotive vehicle bodywork parts, application being effected by electrostatic means (the paint in powder form, electrically charged, is deposited on the surface of the object to be coated, which is connected to earth). This application by electrostatic means most often raises a problem in the case of powder-type paints containing metallic particles, i.e. that the metallic particles tend to separate from the resin particles, taking account specifically of differences in conductivity and density between these materials, which adversely affects the-effectiveness and the homogeneity of application, inasmuch as the metal/resin ratio develops during application. This development of the metal/resin ratio is accentuated even further when the paint in powder form which is not deposited is recycled and re-injected into the spraying system, as is most often the case with electrostatic application.

The pigmentary compositions of U.S. Pat. No. 4,434,009 wherein the metallic particles are coated with a fine layer of polymers make it possible to avoid the aforesaid problems within a powder-type paint composition, in particular insofar as the polymer layer improves the homogeneity of the behaviour of the different powdery materials present in the paint composition.

However, despite the above advantages, the process of U.S. Pat. No. 4,434,009 has one major drawback, i.e. that of being conducted within an organic solvent medium, which is incompatible with the current development of legislation regarding discharge into the environment, displaying a desire to reduce the proportion of volatile organic compounds discharged.

Consequently, it would be specifically advantageous to obtain aluminium particles of the type of those of U.S. Pat. No. 4,434,009, by employing a process which does not use an organic solvent.

Within this framework, it has been disclosed by Batzilla and Tulke, in the Journal of Coatings Technology (volume 70, No. 881, pages 77 to 83, 1998), a process for coating aluminium particles with polymers employing an aqueous medium, which consists in:

pre-treating the surface of the aluminium particles with complexing agents of organophosphate type, in order to confer protection of the aluminium particles against corrosion in an aqueous medium, then

placing the aluminium particles thus protected in suspension in an aqueous medium; then

bringing about polymerisation in the medium obtained, by introducing monomers and a polymerisation initiator.

This original process certainly proves “cleaner” than the process of U.S. Pat. No. 4,434,009, insofar as it does not employ an organic solvent medium, but an aqueous medium. However, on the other hand, it proves more troublesome, given that the employment of an aqueous medium requires the use of complexing agents, the manufacture of which is relatively complex. In addition, and above all, in the process described by Batzilla and Tulke, the protection against the aqueous medium which is conferred by the organophosphate agents is relative. In this regard, Batzilla and Tulke especially state that protection is ensured only at temperatures below 60° C., uncontrollable reactions of the aluminium with the water being observed above that temperature. This limitation of the temperature usable during the polymerisation step limits in particular the possibilities of adapting the nature of the monomers used and their conditions of use. It follows that the process of Batzilla and Tulke leads in general to the production of coated particles of lesser quality than that of the particles obtained according to the process employed in a solvent medium of the aforesaid U.S. Pat. No. 4,434,009.

The present invention aims at providing a process for coating aluminium particles with polymers which, like the process of Batzilla and Tulke, does not require the use of an organic solvent medium, but which further allows to reach this objective with a reduced cost, and by additionally obtaining aluminium particles having a quality at least as good as that of the polymer-coated aluminium particles obtained by the processes employing solvent media such as those described in U.S. Pat. No. 4,434,009.

To this end, one subject-matter of the present invention is a process for coating aluminium particles with a layer of polymer, which comprises the successive steps consisting in:
(A) preparing an aqueous dispersion of particles of metallic aluminium by means of surfactants, the said aluminium particles being brought into contact with persulphate anions S₂O₈²⁻; and then
(B) carrying out an emulsion polymerisation within the aqueous dispersion obtained by step (A), preferably by introducing into the said dispersion monomers the radical polymerisation of which is initiated by the persulphate anions, or, alternatively, by introducing into the said dispersion monomers and a polymerisation initiator for these monomers, whereby a polymer layer forms on the surface of the aluminium particles.

The present invention is based on an unexpected observation made by the inventors, that is, that the presence of persulphate anions S₂O₈²⁻ within an aqueous medium brought into contact with metallic aluminium particles induces a reduction in the speed of corrosion and oxidation of the surface of the metallic aluminium particles by the aqueous medium, which especially induces strong inhibition of the formation of an oxidation layer at the surface of the particles and therefore in the maintenance of the brilliance properties of the particles if the particles are not left for too long periods in contact with the aqueous medium.

This effect of inhibition of the corrosion and oxidation by water in the presence of S₂O₈²⁻ anions which was discovered by the inventors may be demonstrated in particular by measuring the amount of hydrogen emitted by a dispersion of aluminium particles in an aqueous medium containing persulphate anions, compared with the amount of hydrogen emitted by an aqueous dispersion of aluminium particles placed under the same conditions, but not containing persulphate anions. It was found, within the framework of such tests (“gassing tests”), that the presence of S₂O₈²⁻ anions makes it possible to reduce considerably the speed of formation of hydrogen and also the amount of hydrogen given off.

In the process of the present invention, this effect of intermediate protection of the aluminium particles by the S₂O₈²⁻ anions which was discovered by the inventors is employed from in order to effect the dispersion of the aluminium particles of step (A) without the presence of the aqueous medium inducing a reduction in the brilliance qualities of the particles. In step (B), final protection of the particles against corrosion and oxidation is obtained by the polymer layer which coats the particles.

Surprisingly, the work carried out by the inventors has established that the effect of protection of the aluminium particles against an aqueous medium, conferred by persulphate anions S₂O₈²⁻, is clearly greater than the effect obtained by employing the more elaborate and more troublesome protective agents which are currently considered for obtaining such a protective effect, such as the complexing agents of the organophosphate type used in the aforesaid article by Batzilla and Tulke. In particular, the inventors have demonstrated that, surprisingly, the persulphate anions S₂O₈²⁻ make it possible to obtain protection such that the polymerisation step (B) may be implemented at much higher temperatures than with the complexing agents of the organophosphate type of Batzilla and Tulke. This significant stabilisation conferred by the persulphate anions S₂O₈²⁻ makes it possible to adapt the conditions of the polymerisation step (B), especially with regard to the temperature at which this step is conducted, thereby making it possible to obtain particles exhibiting qualities at least as good as, and generally better than, those of the polymer-coated aluminium particles currently known.

Moreover, it turns out that the persulphate anions S₂O₈²⁻ which provide the provisional protection of the aluminium particles against corrosion in an aqueous medium in step (A) are agents known as initiators of radical polymerisation which are advantageously usable in step (B) of the process. As a result, the use of the persulphate anions S₂O₈²⁻ in the process of the invention, as protection agent, most often proves economically advantageous, especially when the monomers of step (B) are compounds having a radical polymerisation initiated by the persulphate anions introduced in step (A): in this case, the provisional protection against corrosion in step (A) and the initiation of polymerisation in step (B) are provided by the same relatively trouble-free compound.

Preferred conditions for the implementation of the process of the invention will now be explained below.

### Step (A)

Characteristically, step (A) of the process of the invention consists in preparing an aqueous dispersion of particles of metallic aluminium in the presence of surfactants, and bringing the aluminium particles into contact with persulphate anions S₂O₈²⁻.

By “particles of metallic aluminium” (or “aluminium particles”) it is understood, within the meaning of the present description, particles comprising aluminium in the metallic state. In these particles, the total quantity of elemental aluminium preferably represents at least 50% by mass, advantageously at least 70% by mass, and even more preferably at least 90% by mass in relation to the quantity of metallic elements present in the said particles. Moreover, in metallic aluminium particles according to the invention, it is most often preferred that the quantity of aluminium in the metallic state represents at least 90% of the total quantity of aluminium (advantageously at least 95%, and even more preferably at least 98%, and specifically advantageously at least 99%, or even 99.5%). Especially preferably, the particles employed in the invention are particles which are substantially based on metallic aluminium, that is to say, particles consisting to the extent of at least 99.5% by mass (preferably at least 99.7% by mass, and even more preferably at least 99.9% by mass) of aluminium in the metallic state. They are moreover most often particles which have never been brought into contact with an aqueous medium and which preferably have the greatest possible brilliance.

Especially, when the process of the invention aims at providing compositions for employment in paints with a metallised appearance, the particles employed in step (A) are advantageously anisotropic particles having average dimensions of 500 microns or less, preferably less than 300 microns, and advantageously less than 100 microns, which behave, schematically, like small plane mirrors reflecting the light. Thus, most frequently, they are flake type particles, having an average transverse diameter of 500 microns or less, preferably between 1 and 400 microns, this average diameter being more preferably 250 microns or less, and more advantageously 100 microns or less, and having an average thickness of 3 microns or less, and preferably between 0.1 and 2 microns. In general, the form factor of the particles employed in step (A) is between ⅕ and 1/1000, and preferably between 1/10 and 1/100.

Moreover, whatever their exact morphology may be, the particles employed in step (A) most often have a specific surface area of between 0.5 and 100 m²/g, the specific surface area being advantageously between 1 and 10 m²/g, for example of the order of 5 m²/g.

By way of example of aluminium particles especially suitable for implementation of the process of the invention, reference may e.g. be made to the particles marketed under the name Alpate by Toyal Europe S.A., Toyal America Inc. or Toyo Aluminium K.K.

In step (A), the presence of the persulphate anions S₂O₈²⁻ provides intermediate protection of the surface of the particles against water corrosion. The persulphate anions are generally introduced into the medium of step (A) in the form of water-soluble salts such as, for example, in the form of sodium persulphate, potassium persulphate and/or ammonium persulphate.

Whatever the form in which they are introduced, the persulphate anions provide protection of the particles which becomes greater when their content in the medium increase, when they are used in low proportions. Thus, especially in order to obtain effective protection of the particles against water corrosion, it is preferred in general that, in step (A), the persulphate/aluminium ratio is at least of 1 micromole of persulphate anions, and advantageously at least 5 micromoles of persulphate anions per m² of surface area developed by the aluminium particles, and that this ratio remains at or below 1000 micromoles of persulphate anions per m² and, most frequently, 500 micromoles of persulphate anions per m² of surface area developed by the aluminium particles. Thus, this ratio advantageously ranges between 5 and 100 micromoles (for example between 10 and 50 micromoles) of persulphate anions per m² of surface area developed by the aluminium particles.

It is generally preferable that, in step (A), the aluminium particles are brought into contact with the persulphate anions S₂O₈²⁻ before any contact with water, thereby making it especially possible to avoid at best the degradation of the brilliance qualities of the aluminium particles. Thus, according to a preferred embodiment, step (A) comprises firstly a step of pre-treatment of the aluminium particles by persulphate anions S₂O₈²⁻ within a non-aqueous medium and then only are the particles thus treated dispersed in an aqueous medium. This embodiment, which has the advantage of avoiding any contact of the aqueous medium with the particles not treated by the persulphate anions S₂O₈²⁻is specifically recommended when the aqueous medium employed is capable of being specifically corrosive or oxidative to untreated particles and/or when it is desired to limit as far as possible the formation of a layer of oxide on the surface of the particles, and/or to preserve the optical properties of the starting particles. According to this embodiment, the non-aqueous medium used in the pre-treatment step may advantageously be an alcohol such as an alkanol, an alkoxyalkanol or a mixture of such compounds, for example. Typically, the non-aqueous medium used is advantageously selected from isopropanol CH₃CH(OH)CH₃, 2-methyl-2-propanol (CH₃)₃COH, propyleneglycol monomethyl ether CH₃O—CH₂CH(OH)CH₃ and dipropyleneglycol monomethyl ether CH₃OC₃H₆OC₃H₆OH, and mixtures of these alcohols. Derivatives of the aforesaid alcohols may also be used.

Whatever the nature of the non-aqueous medium used, a step of pre-treatment of aluminium particles by persulphate anions S₂O₈²⁻ within a non-aqueous medium, according to the process of the invention, is preferably carried out by bringing into contact salts of the persulphate anions S₂O₈²⁻, generally in powdery solid form, with aluminium particles in the form of a paste, that is to say, a concentrated medium of aluminium particles moistened by a non-aqueous medium (dispersion in the non-aqueous medium, generally containing from 60 to 80%, for example from 65 to 75% by mass, of aluminium particles). Typically, such a paste of aluminium particles in a non-aqueous medium (such as an alcohol) may be prepared by starting from aluminium particles in the form in which they are more customarily marketed, i.e. in the form of dispersions in a solvent such as white spirit. A paste of aluminium in a given non-aqueous solvent may be obtained by filtering these commercial dispersions, then washing the filter cake obtained with the given non-aqueous solvent. At the end of several washings, a moist filter cake is obtained which is in the form of a paste of aluminium particles having the same characteristics as in the initial solvent, but dispersed in another medium, such as an alcohol. When the process of the invention is conducted in this particular manner, it is most often advantageous for the filtration steps to be performed without drying the aluminium particles, that is, always maintaining the particles in the form of a dispersion or a moist cake, preferably ensuring that the aluminium content in the paste at no time exceeds 80% by mass, this content advantageously remaining at or below 75% by mass. This precaution makes it possible in particular to avoid interparticulate agglomeration.

According to another embodiment, it is conceivable that step (A) does not to include a step of specific pre-treatment of the particles by the S₂O₈²⁻ anions prior to bringing the particles into contact with the aqueous medium. According to this embodiment, step (A) actually consists in general in directly effecting the dispersion of the aluminium particles within an aqueous medium in the presence of the persulphate anions and surfactants, step (A) being then preferably conducted at a temperature below 60° C., and preferably below 50° C. According to this specific embodiment, the dispersion of step (A) is advantageously conducted by dispersing the aluminium particles within an aqueous medium initially containing the persulphate anions, while avoiding bringing the aluminium particles into contact with an aqueous medium not containing the persulphate anions, so as to avoid corrosion by the aqueous medium. Nevertheless, it is not excluded to bring the aluminium particles temporarily into contact with an aqueous medium not containing persulphate anions, provided however that this contact is made for a sufficiently short time and at a low enough temperature to avoid corrosion of the particles, which would induce in particular the degradation of the brilliance qualities of the particles.

More generally, in the cases where step (A) comprises intermediately a temporary contact of the aluminium particles with an aqueous medium in the absence of persulphate anions, this contact is preferably effected at a temperature below 60° C., more advantageously below 50° C. and even more advantageously below 40° C., and the contact time between the aqueous medium and the aluminium particles in the absence of persulphate anions is advantageously as short as possible, and especially the higher the temperature. In the most general case, this contact time is preferably of the order of a few minutes at most. Thus, for example, at a temperature of 40° C. or less, the contact time is preferably 5 minutes or less. The contact time may nevertheless be longer, in particular if the temperature is lower. Thus, if the contact is effected at a temperature of 20° C. or less, a contact time of up to 20 minutes may be envisaged.

It should be emphasised that, in step (A), the presence of additional agents providing protection of the surface of the particles against water, other than persulphate anions, is not excluded, but it is absolutely not necessary. As a consequence, most frequently, especially for reasons of cost, step (A) is conducted in the absence of any agent providing protection of the aluminium particles against water, other than the persulphate anions.

In step (A), the dispersion of the aluminium particles is specifically effected by means of surfactants. By “surfactants”, it is understood herein chemical species of an amphiphilic nature, namely having zones of a hydrophobic nature and zones of a more hydrophilic nature, these chemical species being capable of modifying the surface tension between the aluminium particles and the aqueous medium when they are introduced into the medium in sufficient quantity.

The presence of these surfactants in the medium of step (A) has a double role
(i) on the one hand, these surfactants allow dispersion of the particles within the aqueous medium.

In this connection, it should be noted that it is preferable to select the surfactants so that the dispersion of the particles in the aqueous medium of step (A) is the best as possible, especially so as to reduce agglomeration to a minimum in the subsequent step (B). In addition, optimum dispersion of the particles in step (A) provides most frequently an effective and homogenous coverage of the particles during step (B). In order to obtain optimum dispersion of the particles in step (A), the surfactants used are advantageously ionic surfactants.
(ii) on the other hand, the introduction of surfactants into the medium of step (A) leads to the formation of zones of a hydrophobic nature round the aluminium particles.

These zones of a hydrophobic nature correspond, schematically, to a regrouping of hydrophobic zones of the surfactants at the periphery of the aluminium particles, the surfactants becoming organised in general around the aluminium particles in the form of a system of the lipidic double layer type, wherein the hydrophilic parts of the surfactants move towards the surface of the particles and towards the aqueous medium, and wherein the hydrophobic parts move towards the interior of the system. It is in these zones of a hydrophobic nature that the emulsion type polymerisation of step (B) will then take place. The nature of the surfactant used influences in general the size and the stability of the hydrophobic zones obtained around the aluminium particles and, as a consequence, the polymerisation conditions of step (B).

According to an advantageous variant, the aluminium particles used in step (A) are particles which have initially on their surface, molecules including hydrocarbon chains, said molecules being preferably fatty acids, such as molecules of stearic acid, oleic acid, isostearic acid, or lauric acid, which are commonly used for the preparation of aluminium flakes, especially according to conventional processes, such as the “Hall” process. With such particles bearing hydrocarbon chains on the surface, the surfactants added in step (A) will form a system of the lipidic double layer type with the layer of fatty acids initially present, which has in particular two advantages. Firstly, the fatty acids initially present at the surface of the aluminium particles constitute “initiators” for the formation of the lipidic double layer around the aluminium particles already present on the particle, thereby generally rendering more effective the formation of the system of the lipidic double layer type around the aluminium particles. In addition, the initial presence of hydrocarbon chains at the surface of the aluminium particles also makes it possible to limit the amount of surfactants to be used, which manifests itself in particular in terms of reduced operating costs.

The aluminium particles implemented in step (A) may also be more specific particles such as, for example, aluminium particles having on the surface, groups of the hydrocarbon chain type bonded covalently to the surface of the aluminium particles, such as those described in patent application FR 02 12273, for example. According to a more particular embodiment, the aluminium particles may carry on the surface, groups capable of participating in the polymerisation of step (B). Thus, these groups may for example have functional groups conferring upon them properties of initiation of the polymerisation. These groups may moreover be unsaturated hydrocarbon chains capable of performing the function of monomers in step (B) , the presence of such monomer groups on the particles serving then as an initial anchorage point for the polymers on that surface of the particles, thereby obtaining specifically effective anchorage of the polymer chains formed in step (B) on the particles.

Depending on the initial aluminium particles used in the process and on the characteristics ultimately sought for the coated particles, the exact nature of the surfactants to be used in step (A) may vary in fairly large measure. As a general rule it is however advantageous, in step (A), for the surfactants used to be long carbon chain ionic surfactants. They are preferably halides, (preferably bromides) of tetraalkylammonium in which at least one of the 4 alkyl chains has from 6 to 20 carbon atoms, and preferably from 10 to 18 carbon atoms, these tetraalkylammonium halides being more preferably selected from the halides of di(C₆-C₂₀ alkyl)-dimethylammonium. Advantageously, the surfactants of step (A) are selected from the bromides of di(C₁₀-C₁₈ alkyl)-dimethylammonium. As specifically suitable surfactants, the bromide of didodecyldimethylammonium (DODAB), or the bromide of didecyldimethylammonium (DDAB) may be especially cited.

### Step (B)

Step (B) of the process of the present invention consists in carrying out an emulsion type polymerisation within the dispersion obtained at the end of step (A).

Generally, this polymerisation may schematically be considered as analogous to the emulsion polymerisation of conventional type, in which polymerisation is carried out within micelles of surfactants dispersed within an aqueous medium. Step (B) is substantially a polymerisation of this type, except that the micelles conventionally used are replaced therein by larger systems consisting of aluminium particles surrounded by surfactants. Thus, instead of forming polymers within the hydrophobic interior of micelles as in a conventional emulsion polymerisation, step (B) leads to the polymeric formation in the hydrophobic zones surrounding the aluminium particles, thus leading to the encapsulation of the aluminium particles in a polymer layer.

As a result, the customary conditions of a conventional type of emulsion polymerisation may on the whole be used in step (B).

Generally, especially for reasons of cost, it is most frequently desirable that, in step (B), polymerisation substantially leads to a polymer formation in the form of a layer around the particles and that a minimum of free polymer chains forms within the aqueous medium, that is to say, other than on the surface of the particles. In fact, the formation of such free chains implies the employment of a larger amount of monomers to obtain effective coverage of the aluminium particles. In order to avoid such formation of free polymer chains, which adversely affects the effectiveness of the coverage of the particles in step (B), an advantageous solution consists in using the surfactants at a concentration such that the residual concentration of free surfactants in the medium obtained at the end of step (A) is less than their critical micellar concentration, so that within the medium no micelles are formed in which emulsion polymerisation could take place. In order to promote the formation of the polymer chains on the particles rather than in the free state in the aqueous medium, it most frequently proves advantageous to introduce the monomers in a gradual, controlled manner during step (B), preferably by conjointly introducing one or more initiators, also in a gradual, controlled manner.

Moreover, as in the case of a conventional emulsion polymerisation, it is most often preferable that the monomers used have an affinity for water which is as low as possible, so that they migrate and polymerise preferentially in the hydrophobic zones of the medium. On the other hand, it is preferable that the monomers of step (A) are selected such that the polymer layer formed is a transparent layer, which advantageously modifies as little as possible the metallic appearance and the brilliance of the initial particles. Moreover, as emphasised above in the instant description, it is advantageous for the monomers used to be monomers the radical polymerisation of which is initiated by the persulphate anions introduced in step (A): as a matter of fact, in this case, the process has the advantage of not requiring the addition of extra polymerisation initiators, which has an effect especially in terms of reduced costs. Thus, monomers that are advantageous for use in step (B) are, for example, acrylate and/or methacrylate monomers, preferably acrylates or methacrylates having from 2 to 15 carbon atoms, advantageously from 2 to 10 carbon atoms, such as alkyl acrylates and/or methacrylates, advantageous (meth)acrylates being butyl acrylate and/or methacrylate, ethyl acrylate and/or methacrylate, methyl acrylate and/or methacrylate, 2-ethylhexyl acrylate and/or methacrylate, and mixtures of these monomers.

It should be emphasised that, taking into account the specific nature of the process of the invention, step (B) may be conducted at a relatively high temperature without having an adverse effect on the brilliance properties of the aluminium particles initially introduced, although this step is conducted in an aqueous medium. Thus, the work of the inventors has made it possible to establish that, in a general case, step (B) may be conducted at a temperature above 60° C., which is specifically surprising in view of the results obtained in the state of the art where the use of such temperatures was not to be considered for a process conducted in an aqueous medium. Thus, step (B) may be conducted within a very wide range of temperatures, typically between 15 and 100° C., step (B) being advantageously conducted between 70 and 95° C. This possibility of conducting step (B) at a high temperature makes it possible in particular to benefit from a wide margin of operation when it is desired to adapt the conditions for polymerisation of step (B), insofar as the wide range of temperatures that can be considered permits the use of numerous monomers, with a possible modulation of the conditions of their polymerisation.

Taking into account the different advantages mentioned above, the process of the present invention constitutes an alternative particularly advantageous to the process of polymer coating of aluminium particles known from the prior art. It also has the advantage of leading to specifically advantageous pigmentary compositions.

These pigmentary compositions obtainable according to the process of the invention constitute, according to one particular aspect, another subject of the present invention. The pigmentary compositions in general comprise persulphates, at least in trace amounts, or derivatives of the persulphates used in the process.

Generally, the pigmentary compositions capable of being obtained according to the process of the invention are in the form of a powder, which can be obtained in particular by filtration and drying of the aqueous medium obtained at the end of step (B) of the process of the invention. They may also be in the form of a dispersion of the particles coated with polymer within an aqueous or non-aqueous medium, these dispersions preferably being dispersions concentrated in the form of a paste containing typically of the order of 60 to 90% by mass (for example 65 to 85% by mass) of particles.

The pigmentary compositions obtained according to the process of the present invention are suitable for numerous fields of application. In fact, these pigmentary compositions based on aluminium particles coated with a protective polymer layer have in general a high resistance to oxidation and to corrosion by water and air, associated with a very good compatibility with polymeric materials such as, in particular, resins. These compositions may as a result be used especially for the formulation of paints or inks having a metallised appearance, which formulations may be aqueous, or for the preparation of plastics materials having a metallised appearance.

More specifically, the pigmentary compositions obtained according to the process of the present invention prove specifically well adapted to the formulation of paints having a metallised appearance, in particular to the formulation of powder-type paint having a metallised appearance, of the type intended for application by electrostatic means.

The powder-type paint compositions of metallised appearance which comprise particles of thermosetting resin and a pigmentary composition capable of being obtained according to the process of the present invention, as a pigment with metallised appearance, constitute another specific subject of the invention.

The water-based paint compositions of metallised appearance which contain a pigmentary composition capable of being obtained according to the process of the invention within an aqueous medium constitute yet another subject of the invention.

Different advantages and characteristics, of the invention will further appear from the illustrative examples of implementation disclosed hereinafter.

### EXAMPLE 1

### Preparation of Aluminium Particles Coated with a Layer of Crosslinked Methacrylic Polymer

Step (a1): Preparation of an Aqueous Dispersion of Aluminium Particles Containing Persulphate Ions

10 g of aluminium flakes in the form of a powder and obtained by filtration and drying under vacuum of a dispersion of aluminium flakes in white spirit, marketed under the name “grade SD80” by the company Toyal (dispersion of flakes of lenticular grade, having a d50 of 12 microns), 15 g of 2-methyl-propan-1-ol and 1.5 g of potassium persulphate were mixed in a beaker.

To the obtained mixture was then added an aqueous solution of didodecyldimethylammonium bromide (DODAB) obtained by completely dissolving 130 mg of DODAB in 200 ml of demineralised, de-gassed water brought to 35° C. while agitating.

The mixture obtained was agitated for 3 minutes on a magnetic agitator, then added to a 2 litre reactor containing 500 ml of demineralised, de-gassed water, agitated at 350 r.p.m. and brought to 80° C. The beaker was rinsed with 0.3 litre of de-gassed water and the washings were introduced into the reactor.

The medium obtained was stabilised and maintained at 80° C. while agitating at 350 r.p.m. for 10 minutes.

Step (b1): Polymerisation within the Dispersion Produced

Into the medium obtained at the end of step (a1), 2 ml of butyl methacrylate (MABu) were introduced in one hour, at a constant rate of 2 ml per hour. After complete addition of the 2 ml of MABu, the medium was agitated for 10 minutes.

Into the medium were then introduced 2 ml of a mixture consisting of 80% by volume of methyl methacrylate (MMA) and 20% by volume of ethyleneglycol dimethacrylate (crosslinking agent). The addition of this mixture was carried out in one hour, at a constant rate of 2 ml per hour. After complete addition of the 2 ml of mixture, the medium was agitated for 10 minutes.

The reactor was then brought to a temperature of 90° C. and the medium was left at this temperature for 1 hour.

At the end of the reaction, the contents of the reactor were emptied into a beaker containing 2 litres of demineralised water, and the medium obtained was agitated overnight (12 hours) until cooled. The medium was then filtered on a sinter and rinsed with 2 litres of demineralised water. The particles recovered on the filter were dried under vacuum at 20° C. for 2 hours and they were then placed in an oven at 40° C. for 7 days.

At the end of these different steps, 12.8 g of aluminium particles coated with a polymer layer were obtained.

### EXAMPLE 2

### Process for Coating Aluminium Particles with a Layer of Methacrylic Polymer

Step (a2) Preparation of an Aqueous Dispersion of Aluminium Particles Containing Persulphate Ions

In this example, the preparation of the dispersion was carried out by preparing a pre-dispersion of the aluminium particles in Dowanol^{(R)} PM (1-methoxy-2-propanol), thereby making it possible to improve the quality of the dispersion of aluminium particles prior to their being coated by the polymer layer.

In order to prepare the pre-dispersion, 80 g of aluminium particles in the form of a dried powder obtained from grade SD80 as employed in example 1, and 200 ml of Dowanol^{(R)} PM as dispersion medium, were introduced into a beaker, and the mixture was subjected to ultrasound treatment for one minute.

A dispersion of aluminium particles usable according to the process of the invention was then prepared starting from the pre-dispersion thus obtained under the following conditions.

To the beaker containing the pre-dispersion of the aluminium particles in Dowanol^{(R)} PM prepared previously was added an aqueous solution of didecyldimethylammonium bromide (DDAB). The DDAB solution used within this framework had been prepared by dissolving in 0.5 litre of de-gassed water at 40° C. a mass of 4 g of a gel consisting of 75% by mass of DDAB in water.

To the medium there was then added a solution of 8 g of potassium persulphate dissolved in 0.5 litre of demineralised and de-gassed water.

The mixture thus obtained in the beaker was agitated for 3 minutes on a magnetic agitator, then it was added to a 3 litre reactor containing 500 ml of demineralised and de-gassed water, agitated at 250 r.p.m. and brought to 70° C. The beaker was rinsed with 0.5 litre of de-gassed water and the washings were introduced into the reactor.

The medium obtained was maintained at 70° C. while agitating at 250 r.p.m. for 2 minutes.

Step (b2): Polymerisation within the Dispersion Produced

Into the medium obtained at the end of step (a2), 16 ml of MABU were introduced at a constant rate of 8 ml per hour. After complete addition of the 16 ml of MABu, the medium was agitated for 40 minutes.

Into the medium were then introduced 16 ml of a mixture consisting of 80% by volume of MABu and 20% by volume of MMA. The addition of this mixture was carried out at a constant rate of 8 ml per hour. After complete addition of the 16 ml of mixture, the medium was agitated for 10 minutes.

The reactor was then brought to a temperature of 90° C. and the medium was left at this temperature for 90 minutes.

At the end of the reaction, the contents of the reactor were emptied into a beaker containing 2 litres of demineralised water, and the medium obtained was agitated overnight (12 hours) until cooled. The medium was then filtered on a sinter and rinsed with 2 litres of demineralised water. The particles recovered on the filter were placed in an oven at 40° C. for 2 days.

At the end of these different steps, 116 g of aluminium particles coated with a polymer layer having a reduced interparticulate agglomeration rate compared with example 1 were obtained.

### EXAMPLE 3

### Method for Coating Aluminium Particles with a Layer of Polymethacrylate

Step (a3): Preparation of an Aqueous Dispersion of Aluminium Particles Containing Persulphate Ions

In this example, the preparation of the dispersion was carried out by preparing a pre-dispersion of the aluminium particles in Dowanol PM^{(R)} as in example 2. However, in order to improve further the dispersion of the particles, this dispersion was produced without intermediate drying of the aluminium particles, in particular in order to inhibit to the maximum degree the phenomena of interparticulate agglomeration.

More precisely, starting from a paste of aluminium particles dispersed in white spirit (“grade 7601NP” marketed by the company Toyal : dispersion of lenticular particles having a d50 of 23 microns), the substitution of the white spirit present in the initial paste by Dowanol^{(R)} PM was carried out under the following conditions. To 2 kg of grade 7601NP paste having an aluminium particle content of 70% by mass were added 20 litres of white spirit in a 30 litre mixer (this step has in particular the aim of eliminating the excess fatty acids present in the paste and entraining the white spirit initially present in the paste). After 20 minutes' mixing, the dispersion obtained was filtered under vacuum on a static filter (Panfilter) until the disappearance of the supernatant. A moist cake was then recovered on the cloth in the form of a paste, which contained around 67% by mass of aluminium. This paste was mixed again for 20 minutes in a mixer with 20 litres of Dowanol^{(R)} PM, and the dispersion obtained was filtered under vacuum until a cake was obtained in the form of a paste containing around 67% of aluminium. The paste obtained was again mixed in 20 litres of Dowanol^{(R)} PM for 20 min., then filtered again until the disappearance of the supernatant.

At the end of these different steps, a paste was obtained containing 67% by mass of aluminium particles and 35% by mass of Dowanol^{(R)} PM. The particle size of the aluminium particles in the paste thus obtained is the same as that of the initial standard paste.

This paste was used for the preparation of a dispersion of aluminium particles usable according to the process of the invention under the following conditions. 600 ml of de-gassed water at 70° C. and 6 g of an aqueous gel containing 75% by mass of DDAB, then 20 g of potassium persulphate, were mixed in a beaker while agitating. To this medium were gradually added, still agitating, 350 g of the previously prepared aluminium paste.

The mixture thus obtained in the beaker was agitated for 3 minutes on a mechanical agitator (motor block driving a turbine type blade at 300 r.p.m.), then passed for 30 seconds under ultrasound.

The mixture thus prepared was introduced into a 3 litre reactor containing 1 litre of demineralised, de-gassed water, agitated at 300 r.p.m. and brought to 70° C. The beaker was rinsed with 0.75 litre of de-gassed water and the washings were introduced into the reactor.

The medium obtained was maintained at 70° C. while agitating at 300 r.p.m. for 10 minutes.

Step (b3): Polymerisation within the Dispersion Produced

Into the medium obtained at the end of step (a4), 10 ml of MABU were introduced at a constant rate of 10 ml per hour. After complete addition of the 10 ml of MABu, the medium was agitated for 180 minutes. Heating was then discontinued and the reactor was allowed to cool while agitating.

At the end of the cooling, the contents of the reactor were emptied, and the medium was screened at 500 and 200 μm, then filtered on a sinter and washed with 10 litres of demineralised water. The particles recovered on the filter were dried in an oven at 40° C. for 15 days.

At the end of these different steps, 233 g of aluminium particles (passing 200 μm) coated with a polymer layer were obtained.

### EXAMPLE 4

### Process for Coating Aluminium Particles with a Layer of Methacrylic Polymer

Step (a4): Preparation of an Aqueous Dispersion of Aluminium Particles Containing Persulphate Ions.

In this example, the preparation of the dispersion was carried out in a similar manner to example 3, starting from a paste of aluminium particles dispersed in white spirit, of grade 7601NP, wherein the white spirit was substituted by Dowanol PM^{(R)} by a succession of mixing and filtration operations, without intermediate drying of the particles. The exchange of the solvent in the pigmentary paste was carried out under the same conditions as in example 3, except for the difference that, during the last mixing, DDAB was added to the medium in the form of an aqueous gel containing 75% by mass (or 15 g) of DDAB, and that the paste obtained after the last filtration was brought to 40° C. in an oven until a content of 5% by mass of Dowanol PM, and 95% by mass of aluminium particles was obtained. The DDAB fixed in part on the aluminium particles, and the excess of this surfactant, not located on the particles, was substantially eliminated during the filtration steps.

The paste thus obtained was used for the preparation of a dispersion of aluminium particles usable according to the process of the invention under the following conditions, similar to those of example 4.

600 ml of de-gassed water at 70° C. and 6 g of an aqueous gel containing 75% by mass of DDAB, then 10 g of potassium persulphate, were mixed in a beaker while agitating. To this medium there were gradually added, still agitating, 100 g of the previously prepared aluminium paste.

The mixture thus obtained in the beaker was agitated for 3 minutes on a mechanical agitator and then passed for 30 seconds under ultrasound.

The mixture thus prepared was introduced into a 3 litre reactor containing 1 litre of demineralised, de-gassed water, agitated at 250 r.p.m. and brought to 70° C. The beaker was washed with 0.4 litre of de-gassed water and the washings were introduced into the reactor.

The medium obtained was maintained at 70° C. while agitating at 250 r.p.m. for 2 minutes.

Step (b4): Polymerisation within the Dispersion Produced

Into the medium obtained at the end of step (a4), 10 ml of MABu were introduced at a constant rate of 10 ml per hour. After complete addition of the 10 ml of MABu, the medium was agitated for 20 minutes.

2 g of potassium persulphate were then introduced into the reactor and the medium was agitated at 70° C. for 16 hours. Heating was then discontinued and the reactor was allowed to cool while agitating.

At the end of this cooling, the contents of the reactor were emptied, and the medium was screened at 500 and 200 μm, then filtered on a sinter and washed with 3 litres of demineralised water. The particles recovered on the filter were dried in an oven at 40° C. for 15 days.

At the end of these different steps, 127 g of aluminium particles coated with a polymer layer were obtained.

In general, the particles coated with the polymer layers which were obtained according to the process of the present invention most often have characteristics of metallic brilliance closely similar to those of the initial aluminium particles.

In order to evidence this effect, the particles obtained at the end of example 4 were compared with the initial grade 7601NP particles, within a blue formulation. In both cases, an identical quantity of metallic aluminium was introduced and the calorimetric co-ordinate b was measured (in the CIE Lab system), which corresponds to the axis going from yellow (positive b values) to blue (negative b values). Thus the more negative the value of b, the more intense the blue coloration.

In the test carried out, the blue formulation obtained starting from the standard grade 7691NP paste had a value b of −29.9±1.0, while the blue formulation obtained starting from the particles synthesised at the end of example 4 had a value b of −29.3±1.0.

The coated aluminium particles exhibit visually optical characteristics analogous to those of the initial aluminium particles.

1-18. (canceled)

19. A process for coating aluminium particles with a polymer layer, comprising the steps consisting in:
(A) preparing an aqueous dispersion of particles of metallic aluminium by means of surfactants, the said aluminium particles being brought into contact with persulphate anions S₂O₈²⁻; and then
(B) carrying out emulsion polymerisation within the aqueous dispersion obtained at the end of step (A), by introducing into the said dispersion monomers the radical polymerisation of which is initiated by the persulphate anions, or by introducing into the said dispersion monomers and a polymerisation initiator for these monomers, whereby a polymer layer forms on the surface of the aluminium particles.

20. The process of claim 19, wherein step (A) comprises a step of pre-treatment of the aluminium particles by S₂O₈²⁻ anions within a non-aqueous medium, and the particles thus treated are then dispersed in an aqueous medium in the presence of the said surfactants.

21. The process of claim 20, wherein the non-aqueous medium used in the pre-treatment step is an alkanol, an alkoxyalkanol or a mixture of such compounds, the medium being advantageously selected from isopropanol (CH₃CH(OH)CH₃), 2- methyl-2-propanol (CH₃)₃COH, propyleneglycol monomethyl ether CH₃O—CH₂CH(OH)CH₃ and dipropyleneglycol monomethyl ether CH₃OC₃H₆OC₃H₆OH, and mixtures of these alcohols.

22. The process of claim 19, wherein step (A) consists in directly effecting the dispersion of the aluminium particles within an aqueous medium in the presence of the persulphate anions and surfactants.

23. The process of claim 22, wherein step (A) is conducted at a temperature below 60° C.

24. The process of claim 19, wherein the persulphate/aluminium ratio in step (A) is between 1 and 1000 micromoles of persulphate anions per m² of surface area developed by the aluminium particles.

25. The process of claim 24, wherein the persulphate/aluminium ratio in step (A) is between 5 and 500 micromoles of persulphate anions per m² of surface area developed by the aluminium particles.

26. The process of claim 19, wherein the aluminium particles in step (A) initially have on their surface molecules including hydrocarbon chains, preferably fatty acids such as molecules of stearic acid or oleic acid.

27. The process of claim 19, wherein the surfactants employed in step (A) are ionic surfactants.

28. The process of claim 25, wherein the surfactants used are halides of di(C₆-C₂₀ alkyl)-dimethylammonium, or other halides of tetraalkylammonium in which at least one of the 4 alkyl chains has from 6 to 20 carbon atoms.

29. The process of claim 26, wherein the surfactants used are selected from bromide of didodecyldimethylammonium (DODAB), bromide of didecyldimethylammonium (DDAB), or other bromides of di(C₁₀-C₈ alkyl)-dimethylammonium.

30. The process of claim 19, wherein the surfactants are employed in a concentration such that the residual concentration of free surfactants in the medium obtained at the end of step (A) is less than their critical micellar concentration.

31. The process of claim 19, wherein the monomers of step (B) are monomers having a radical polymerisation initiated by the persulphate anions introduced in step (A).

32. The process of claim 19, wherein the monomers employed in step (B) are acrylates and/or methacrylates.

33. The process of claim 19, wherein step (B) is conducted at a temperature of more than 60° C.

34. The process according to claim 33, wherein step (B) is conducted at a temperature between 70 and 95° C.

35. A pigmentary composition containing aluminium particles coated with a layer of polymer obtainable according to the process of claim 19.

36. A method of formulation of a paint having a metallised appearance, making use of a composition according to claim 33.

37. A powder-type paint of metallised appearance, comprising particles of thermosetting resin and a composition according to claim 33 as the pigment having a metallised appearance.

38. A water-based paint having a metallised appearance, comprising a composition according to claim 33 dispersed within an aqueous medium.
